(19) United States
(12) Patent Application Publication
(10) Pub. No.: US 2025/0181589 A1
(43) Pub. Date: Jun. 5, 2025

(54) Avoiding Duplication in Evaluating Batches of Segments Against Entity Data

(71) Applicant: Klaviyo, Inc., Boston, MA (US)

(72) Inventors: Patrick McGrath, Jamaica Plain, MA (US); Joshua Bradt, Boston, MA (US); Anton Rodionov, The Hague (NL)

(73) Assignee: Klaviyo, Inc, Boston, MA (US)

(21) Appl. No.: 18/744,859

(22) Filed: Jun. 17, 2024

Related U.S. Application Data
(63) Continuation-in-part of application No. 18/526,131, filed on Dec. 1, 2023.

(51) Int. Cl. G06F 16/2457; G06F 16/242

(52) U.S. Cl. CPC G06F 16/24573; G06F 16/244

(57) ABSTRACT

Apparatuses, methods, and systems for filtering entities within a database. One method includes identifying a user-defined query, wherein the user-defined query comprises multiple user-defined segment definitions, wherein an original format of each of the user-defined segment definitions includes logical filters, mapping each logical filter to one or more of the user-defined segment definitions, executing each of the logical filters on entities of the database, wherein each of the logical filters is executed a single time, storing filtered results in a mapped format based on the executing of the logical filters according to the mapping in the database, converting from the mapped format into the original format of the user-defined segment definitions that represents the set of entities that qualify for user-defined segments, identifying which entities qualify to be included within the user-defined segment definitions comprising logically combining the conditions and the condition groups.

### RELATED PATENT APPLICATIONS

This patent application is a continuation-in-part (CIP) of U.S. patent application Ser. No. 18/526,131, filed Dec. 1, 2023, which is herein incorporated by reference.

### FIELD OF THE DESCRIBED EMBODIMENTS

The described embodiments relate generally to segmenting of data of a database. More particularly, the described embodiments relate to systems, methods, and apparatuses for avoiding duplication in evaluating batches of segments against entity data of a database.

### BACKGROUND

Data Segmentation is the process of taking data and dividing it up and grouping similar data together based on chosen parameters. For example, a shoe company might segment its database to show which customers purchase tennis shoes the most versus which customers purchase dress shoes. An office supply store might segment its business buyers into categories such as “furniture buyers,” “paper buyers” and “printer ink buyers.”

It is desirable to have methods, apparatuses, and systems for avoiding duplication in evaluating batches of segments against entity data.

### SUMMARY

An embodiment includes a computer-implemented method for filtering entities within a database based on rules of a user-defined segment definition. The method includes identifying, by a server, a user-defined query, wherein the user-defined query comprises multiple user-defined segment definitions, wherein an original format of each of the user-defined segment definitions include one or more condition groups, wherein each conditional group includes one or more conditions, wherein each condition includes a logical filter, a field indicating which condition group includes the condition, and fields denoting which user-defined segment definitions include the logical filter, mapping, by the server, each logical filter to one or more of the user-defined segment definitions based on the fields of each condition, and parsing a sub-component of a logical date-filter a single time and storing the sub-component of the logical date-filter in the database when at least one of the logical filters is the logical date-based filter, executing, by the server, each of the logical filters on a plurality of entities of the database, wherein each of the logical filters is executed a single time, storing, by the server, filtered results in a mapped format based on the executing of the logical filters according to the mapping in the database, converting, by the server, from the mapped format into the original format of the user-defined segment definitions that represents the set of entities that qualify for user-defined segments, identifying, by the server, which entities qualify to be included within the user-defined segment definitions comprising logically combining the conditions and the condition groups, and electronically performing, by the server, an action directed to users of the entities qualified to be within the user-defined segment definitions.

Another embodiment includes a system for filtering entities based on rules of a user-defined segment definition. The system includes a server, a database, wherein entities are stored in the database, a user server electronically connected to the server, and sub-user computing devices electronically connected to the server and the user server, wherein the entity data includes data of sub-users of the sub-user computing devices. The server is configured to identifying a user-defined query, wherein the user-defined query comprises multiple user-defined segment definitions, wherein an original format of each of the user-defined segment definitions include one or more condition groups, wherein each conditional group includes one or more conditions, wherein each condition includes a logical filter, a field indicating which condition group includes the condition, and fields denoting which user-defined segment definitions include the logical filter, map each logical filter to one or more of the user-defined segment definitions based on the fields of each condition, and parsing a sub-component of a logical date-filter a single time and storing the sub-component of the logical date-filter in the database when at least one of the logical filters is the logical date-based filter, execute each of the logical filters on a plurality of entities of the database, wherein each of the logical filters is executed a single time, store filtered results in a mapped format based on the executing of the logical filters according to the mapping in the database, convert from the mapped format into the original format of the user-defined segment definitions that represents the set of entities that qualify for user-defined segments, identifying which entities qualify to be included within the user-defined segment definitions comprising logically combining the conditions and the condition groups, and electronically performing an action directed to sub-users of the entities qualified to be within the user-defined segment definitions.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows a system for avoiding duplication in evaluating batches of segments against entity data, according to an embodiment.

FIG. 2 is a flow chart that includes steps of a method for avoiding duplication in evaluating batches of segments against entity data, according to an embodiment.

FIG. 3 is a table that shows entity (profile) data stored in a database, according to an embodiment.

FIG. 4 shows a table of segments stored according to an original format in a database, according to an embodiment.

FIG. 5 shows a table created according to a mapped format allowing each condition to be analyzed once, according to an embodiment.

FIG. 6 shows a system for storing user-defined query logic in a database for filtering entity data, according to an embodiment.

FIG. 7 is a flow chart that includes steps of a method for storing user-defined query logic in a database for filtering entity data, according to an embodiment.

FIG. 8 shows tables of profile data, according to an embodiment.

FIG. 9 shows tables of user-defined segment definitions, according to an embodiment.

FIG. 10 shows additional tables of user-defined segment definitions, according to an embodiment.

FIG. 11 shows a user interface of a system for storing user-defined query logic in a database for filtering entity data, according to an embodiment.

### DETAILED DESCRIPTION

The embodiments described include methods, apparatuses, and systems for avoiding duplication in evaluating batches of user-defined segment definitions of a user-defined query against entity data of a database. For an embodiment, each of the user-defined segment definitions is composed of multiple user-defined conditions. For an embodiment, when these conditions are evaluated on underlying data (data of entities or profiles within the database) each of these user-defined rules produces a result set, which are then combined using the OR and AND logical operators, to produce a final resulting set for the segment. More specifically, for an embodiment, each of the user-defined segment definitions have multiple condition groups. For an embodiment, the logic of each condition group is combined using an AND operator. For an embodiment, each condition group has multiple conditions. For an embodiment, the logic of these conditions, within a condition group, are combined using an OR operator for determination of whether the underlying data satisfies the conditions of the segment.

When evaluating multiple user-defined segment definitions of a user-defined query together in a SQL (structured query language) query, commonly multiple of the rules (user-defined conditions) are identical. Without any optimization the evaluation of such a set of conditions leads to the performance of unnecessary work due to reevaluating a given condition multiple times. The described embodiments provide ways for optimally evaluating the user-defined rules (user-defined conditions) in a way that avoids the duplicate evaluation of a given condition. Accordingly, the described embodiments improve the computing process of evaluating conditions of the user-defined rules on the underlying data and producing a result set by reducing the duplication of evaluating the conditions. The reduction or elimination of duplication of evaluating conditions greatly improves the speed and efficiency of processing of the server or computer performing the processing.

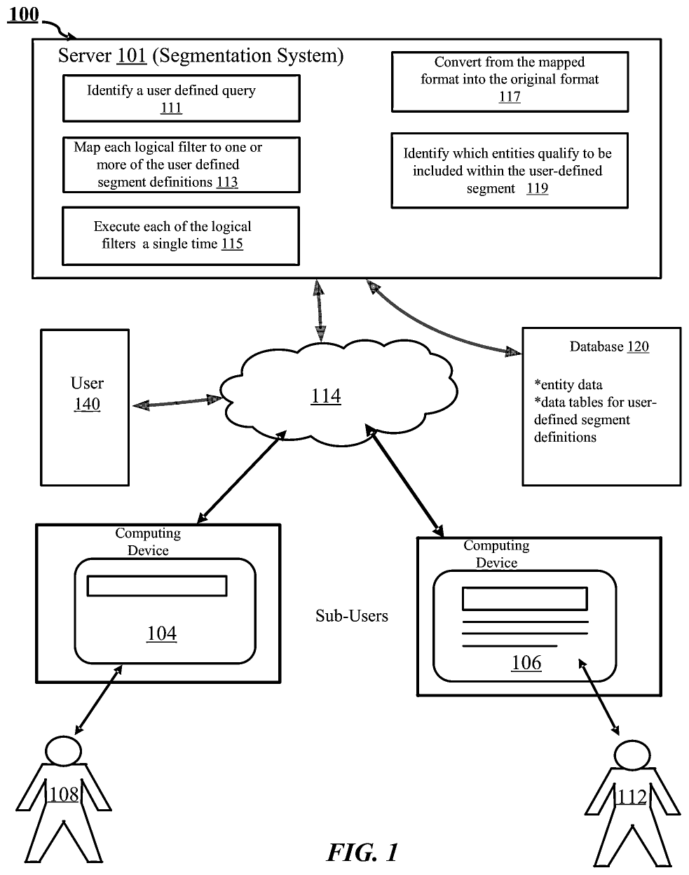

FIG. 1 shows a segmentation system 100 for avoiding duplication in evaluating batches of segments against entity data, according to an embodiment. As shown, the system 100 includes a server 101 connected through a network 114 to a user server 140, computing devices 104, 106, and a database 120. The server 101 of the segmentation system is configured to evaluate user-defined segment definitions against entity data of sub-users 108, 112 of the computing devices 104, 106 stored in the database 120. The evaluated segment definitions are then used to electronically perform an action directed to users defined by the segment definitions.

For an embodiment, the server 101 is configured to identifying 111 a user-defined query, wherein the user-defined query includes multiple user-defined segment definitions, wherein an original format of each of the user-defined segment definitions include one or more condition groups, wherein each conditional group includes one or more conditions, wherein each condition includes a logical filter, a field indicating which condition group includes the condition, and fields denoting which user-defined segment definitions include the logical filter. The user-defined query can be identified in different ways. For an embodiment, the user-defined query is received by a user (for example, a website operator) of the user server 140. That is, the user may desire segmentation of the entity data of the sub-users 108, 112, and the user-defined query identifies how the user would like the entity data to be segmented.

For an embodiment, the server 101 is configured to map 113 each logical filter to one or more of the user-defined segment definitions based on the fields of each condition, and parsing a sub-component (for an embodiment, sub-component includes a date string in the logical filter) of a logical date-filter a single time and storing the sub-component of the logical date-filter in the database when at least one of the logical filters is the logical date-based filter.

For an embodiment, the server is configured to execute 115 each of the logical filters on a plurality of entities of the database, wherein each of the logical filters is executed a single time. The described embodiments that execute each of the logical filters a single time allows for improved processing and efficiency relative to other implementations of segmentation. Execution of the logical filters includes accessing entity data from the database which is then compared with the conditions of the logical filters. Reducing the accessing associated with each logical filter improves the processing and the efficiency of the operation of the computer or server performing the segmentation.

For an embodiment, the server is configured to store filtered results in a mapped format based on the executing of the logical filters according to the mapping in the database. The mapping maps each logical filter to one or more of the user-defined segment definitions based on the fields of each condition. The mapping includes a map from the original format to the mapped format. In this new representation each unique condition filter is only included once.

Further, alongside the condition filter is a list of all of the references of that condition filter. The advantage of this approach is that each condition filter is only evaluated once. The result of the evaluation of each condition filter is then attributed to every condition using that filter, thereby avoiding duplicate work which makes the system faster.

For an embodiment, the server is configured to convert 117 from the mapped format into the original format of the user-defined segment definitions that represents the set of entities that qualify for user-defined segments.

For an embodiment, the server is configured to identify 119 which entities qualify to be included within the user-defined segment definitions by logically combining the results of each of the conditions and each of the condition groups. For an embodiment, the logical combining includes combining the results by “OR”ing each condition and “AND”ing each condition group to yield as to whether each entity qualifies to be included in the user-defined segment definition. The qualifying entities are segmented results of applying the user-defined query to the entities of the database 120.

For an embodiment, the user of the user server 140 may initiate a segmentation process of information related to the sub-users. For example, the user may desire segmentation of email addresses of the sub-users for facilitating targeted emailing of advertising. For an embodiment, a profile of each of the sub-users is stored in the database 120. For an embodiment, the segmentation includes analyzing information within the profiles (entities) of the sub-users to filter the sub-users based on a user-provided criteria, which can include criteria like “profiles located in New York,” “profiles that have purchased at least 2 pairs of red pants in the last 6 months,” or “profiles whose pre-computed probability of placing an order in the next 30 days is greater than 50%” or combinations of criteria such as these.

For an embodiment, the server 101 configured to execute each of the logical filters on the plurality of entities of the database includes the server 101 being configured to read entities from the database, SQL (structured query language) join the entities to the mapped logical filters, and evaluate each of the logical filters on each of the entities. For an embodiment, the SQL joining includes joining rows across multiple tables based on a join expression. For an embodiment, evaluating each of the logical filters on each of the entities includes determining which of the entities of the database 120 match the requirements of the logical filter being evaluated.

For an embodiment, the sub-component of each logical date-filter includes a date string, wherein the date string includes a start date, an end date, and a unit. For a specific embodiment, the logical date-filter is represented as (′created_timestamp′, ‘between’, ‘1235:1237:’). For an embodiment, the 3rd item in the logical filter is the logical filter value (‘1235:1237:’). An embodiment could include a logical filter that includes 3 fields (the start timestamp, end timestamp, and unit) to represent a date filter.

For an embodiment, the first item of the logical filter value (′created_timestamp′) is the name of the property being filtered. For an embodiment, the second item is the operator (which is “between” in the example). For an embodiment, the third item is the condition. For an embodiment, there are 3 pieces of information of the condition stored here, delimited by colons. As shown, the first (1235) is the start timestamp, the second (1237) is the end timestamp, and the 3rd is the date unit (if present). For an embodiment, the timestamps are Unix timestamps, which are the number of seconds since 1970.

For an embodiment, the format is updated to look something like (′created_timestamp′, ‘between’, 1235, 1237, null). For the updated format, the first and second items are unchanged, the third item (1235) is the start timestamp, the 4th item (1237) is the end timestamp, and the 5th item (null) is the unit. For an embodiment, the 5th item may be ‘day’, other times ‘month’, other times null (if it's not needed).

For an embodiment, parsing a date string of the logical date-filter a single time and storing the parsed date string of the logical date-filter in the database further includes storing a field of each logical date-filter in a dedicated column. For this embodiment, the logical filter value (logical date-filter) is parsed up front, and each field is stored in a dedicated column. This means that the logical filter value does not need to be parsed each time that the logical filter value (logical date-filter) is being evaluated against an entity. That is, the logical filter value (logical date-filter) is parsed once before being stored in the database. This means the logical filter value (logical date-filter) does not need to parse it later after joining the logical filter to the entity. This can result in the filter value being parsed once, instead of up hundreds of thousands or millions of times, thereby greatly improving the performance of the user-defined query.

For an embodiment, the server 101 being configured to identify the user-defined query includes the server 101 being further configured to create data tables for storing user-defined segment definitions in the database, the data tables including the user-defined segment definitions and criteria, wherein the criteria include rules (logical filters) that are evaluated against entity data of the database to determine whether an entity should or should not qualify for a segment based on entity data associated with the entity, receive new user-defined segment definitions, identify the multiple user-defined segment definitions comprising transforming, by the segmentation system, the new user-defined segment definitions, wherein transforming includes representing the new user-defined segment definitions as sets of filter definition tuples, wherein the sets of filter definition tuples are based on the user-defined segment definitions and the criteria in the created data tables, and store the multiple user-defined segment definitions in the database, wherein the multiple user-defined segment definitions, wherein each of the user-defined segment definitions include one or more condition groups, each of which includes one or more conditions, wherein each condition includes a logical filter, a field indicating which condition group includes the condition, and fields denoting which user-defined segment definitions include the logical filter, wherein the user-defined query includes the multiple user-defined segment definitions.

For an embodiment, the server 101 is configured to electronically perform an action directed to users identified by membership in the received new user-defined segment definitions.

The method of claim 1, wherein each of the entities comprises a profile, wherein each profile comprises information of sub-users, wherein the sub-users are customers of the user.

The method of claim 1, wherein each segment includes a list of entities, wherein membership of each of the entities is determined by the composed user-defined query based on the new user-defined segment definitions.

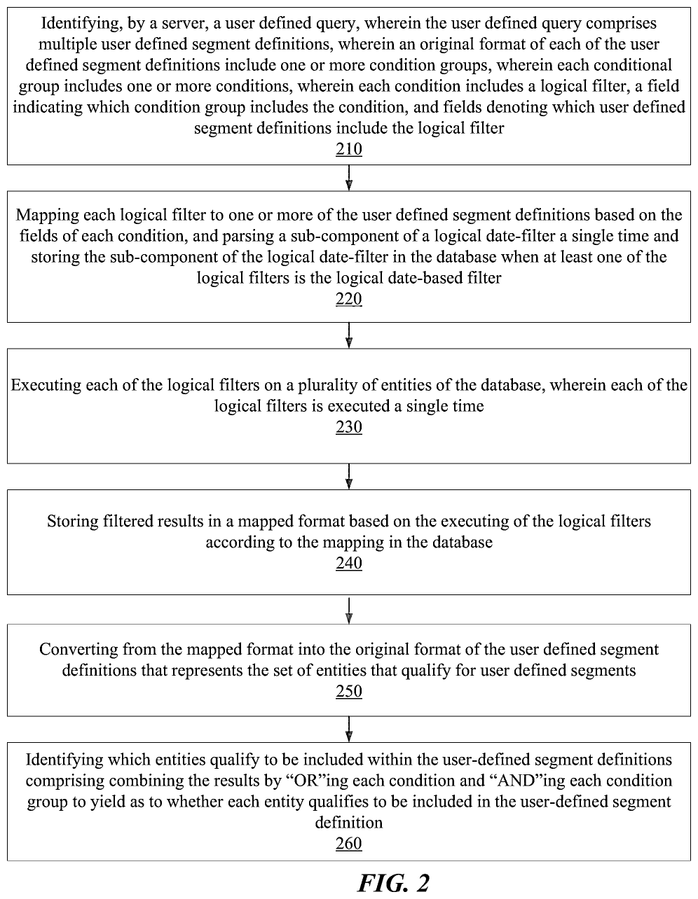

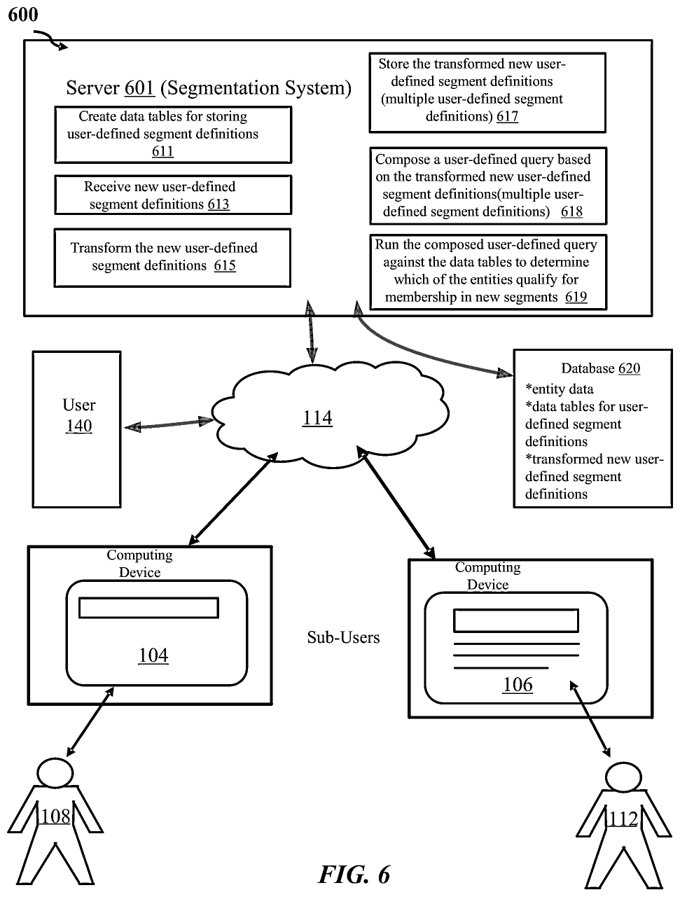

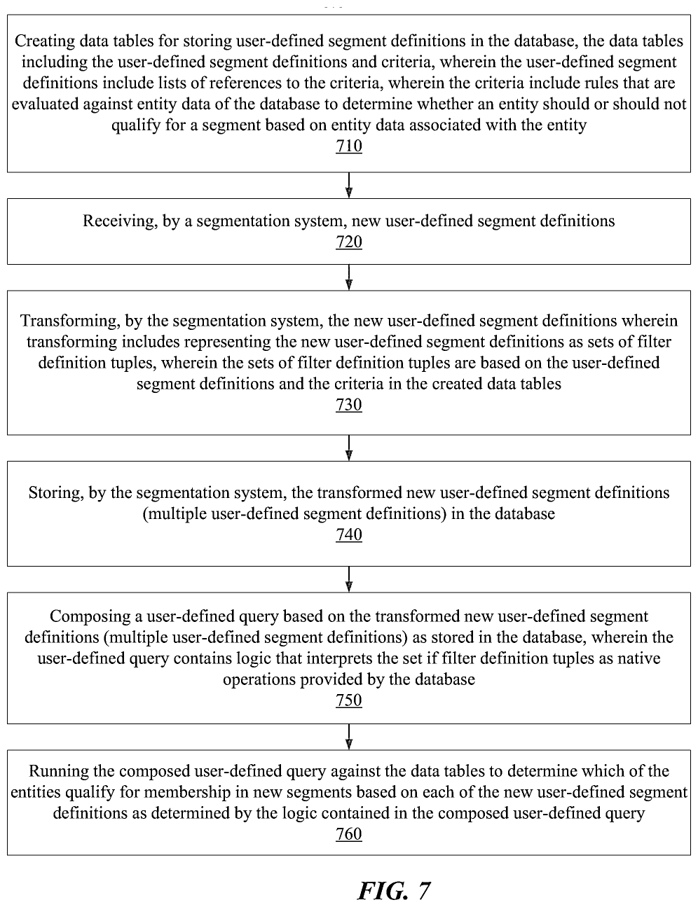

FIG. 2 is a flow chart that includes steps of a method of filtering entities within a database based on rules of a user-defined segment definition. A first step 210 includes identifying, by a server, a user-defined query, wherein the user-defined query comprises multiple user-defined segment definitions, wherein an original format of each of the user-defined segment definitions include one or more condition groups, wherein each conditional group includes one or more conditions, wherein each condition includes a logical filter, a field indicating which condition group includes the condition, and fields denoting which user-defined segment definitions include the logical filter. FIG. 6 and FIG. 7 expand on an embodiment for identifying the user-defined query which includes creating tables within a database and transforming new user-defined segment definitions. A second step 220 includes mapping, by the server, each logical filter to one or more of the user-defined segment definitions based on the fields of each condition, and parsing a sub-component of a logical date-filter a single time and storing the sub-component of the logical date-filter in the database when at least one of the logical filters is the logical date-based filter. A third step 230 includes executing, by the server, each of the logical filters on a plurality of entities of the database, wherein each of the logical filters is executed a single time. For an embodiment execution includes retrieving each of the entities from the database and determining whether which entities have properties that satisfy the logical filters. A fourth step 240 includes storing, by the server, filtered results in a mapped format based on the executing of the logical filters according to the mapping in the database. A fifth step 250 includes converting, by the server, from the mapped format into the original format of the user-defined segment definitions that represents the set of entities that qualify for user-defined segments. A sixth step 260 includes identifying, by the server, which entities qualify to be included within the user-defined segment definitions comprising logically combining the conditions and the condition groups. A seventh step (not shown) includes electronically performing, by the server, an action directed to users of the entities qualified to be within the user-defined segment definitions.

For an embodiment, the logically combining the conditions and the condition groups comprises combining the results by “OR”ing each condition and “AND”ing each condition group. For an embodiment, each entity is composed of properties. The logical filters are evaluated specifically against the properties in each entity.

For an embodiment, executing each of the logical filters on the plurality of entities of the database includes reading entities from the database, SQL joining (joining rows across multiple tables based on a join expression) the entities to the mapped logical filters, and evaluating each of the logical filters on each of the entities. The SQL JOIN clause is used to query and access data from multiple tables by establishing logical relationships between them. The SQL JOIN clause can access data from multiple tables simultaneously using common key values shared across different tables.

For an embodiment, the sub-component of each logical date-filter includes a date string, wherein the date string includes a start date, an end date, and a unit. For an embodiment, parsing the date string of the logical date-filter a single time and storing the parsed date string of the logical date-filter in the database further includes storing a field of each logical date-filter in a dedicated column. For an embodiment, the raw format (date string) needs to be parsed in order to get from the raw format (date string) to something useful. The raw format (date string) can either be parsed every time an evaluation is performed, or the raw format (date string) can be parsed once and the parsed (optimized) format is stored, which is then used for later evaluations which is substantially more efficient.

For at least some embodiments, identifying the user-defined query includes creating data tables for storing user-defined segment definitions in the database, the data tables including the user-defined segment definitions and criteria, wherein the criteria include rules (logical filters) that are evaluated against entity data of the database to determine whether an entity should or should not qualify for a segment based on entity data associated with the entity, receiving, by a segmentation system, new user-defined segment definitions, identifying the multiple user-defined segment definitions comprising transforming, by the segmentation system, the new user-defined segment definitions, wherein transforming includes representing the new user-defined segment definitions as sets of filter definition tuples, wherein the sets of filter definition tuples are based on the user-defined segment definitions and the criteria in the created data tables, and storing, by the segmentation system, the multiple user-defined segment definitions in the database, wherein each of the multiple user-defined segment definitions include one or more condition groups, each of which includes one or more conditions, wherein each condition includes a logical filter, a field indicating which condition group includes the condition, and fields denoting which user-defined segment definitions include the logical filter, wherein the user-defined query comprises the multiple user-defined segment definitions. At least some embodiments further include composing a user-defined query based on the multiple user-defined segment definitions as stored in the database, wherein the user-defined query contains logic that interprets the sets of filter definition tuples as native operations wherein identifying which entities qualify to be included within the user-defined segment definitions comprises running the composed user-defined query against the data tables to determine which of the entities qualify for membership in new segments based on each of the new user-defined segment definitions as determined by the logic contained in the composed user-defined query.

For an embodiment, running the composed user-defined query against the data tables provides a filtered set of entities per the new user-defined segment definitions. At least some embodiments further include electronically performing an action directed to users identified by membership in the new segments. For an embodiment, each segment includes a list of entities, wherein membership of each of the entities is determined by the composed user-defined query based on the new user-defined segment definitions. For an embodiment, each of the entities includes a profile, wherein each profile comprises information of sub-users, wherein the sub-users are customers of the user.

For an embodiment, identifying which entities qualify to be included within the user-defined segment definitions includes filtering for multiple segments simultaneously. The simultaneous filtering is substantially improved because of the previously described mapping because the mapping reduces the amount of duplicate work that needs to be performed.

At least some embodiments further include creating and storing a trait and event table in the database as a part of the entity data of the data tables. For an embodiment, the entity data includes an email address of a sub-user.

For an embodiment, the entity data includes time-series data. For an embodiment, the time-series data includes an electronic history. For an embodiment, the electronic history includes at least one of a purchase history or an email history of a sub-user.

At least some embodiments further include updating the multiple user-defined segment definitions as entity data changes. For an embodiment, this includes sensing changes in the entity data, and automatically re-running the composed user-defined query against the data tables to determine which of the entities qualify for membership in new segments based on each of the new user-defined segment definitions as determined by the logic contained in the composed user-defined query.

As previously described, at least some embodiments include electronically sending messages to sub-users identified by membership in the new segments.

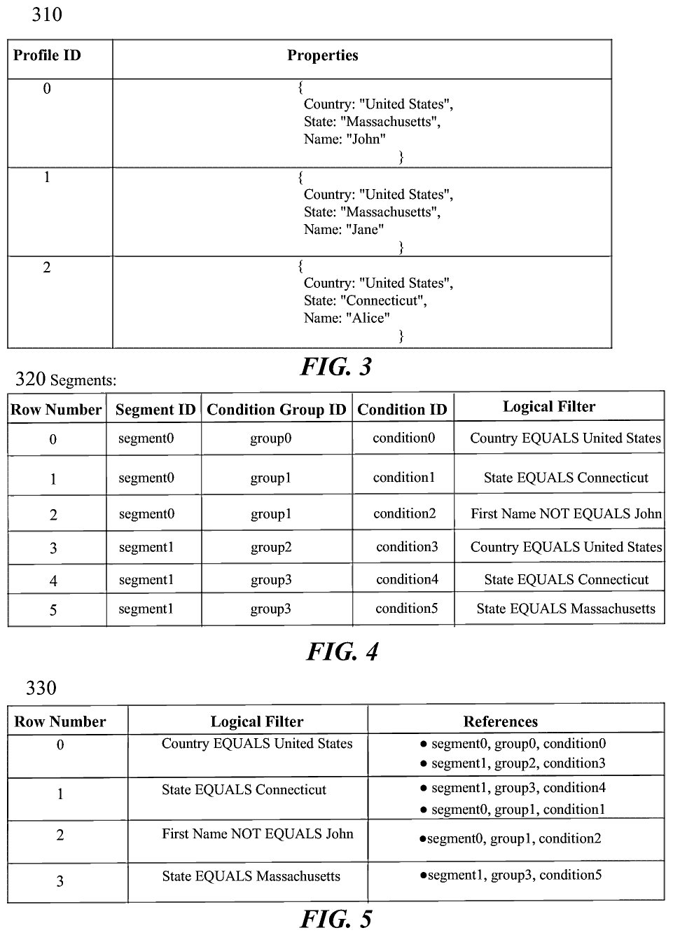

FIG. 3 is a table that shows entity (profile) data stored in a database, according to an embodiment. The table includes profiles having profile IDs 0, 1, and 2. As shown, the profile having the profile ID of 0 includes the properties of a country of the United States, a state of Massachusetts, and a name of John. The profile having the profile ID of 2 includes the properties of a country of the United States, a state of Connecticut, and a name of Jane. United States, a state of Massachusetts, and a name of Alice. For an embodiment, each of the logical filters is evaluated on each of the entities, wherein an entity is composed of one or more properties. The properties represent details for that specific entity, like the first name, last name, and so on. An entity is composed of properties. The logical filters are evaluated specifically against the properties in a given entity.

FIG. 4 shows a table of segments stored according to an original format in a database, according to an embodiment. Typically, segments are based on user-defined sets of rules for filtering data in a database. If the data is stored in a single analytical database, then a natural solution is to write SQL (structured query language) queries to calculate segment memberships based on this data. It is desirable to express the user-defined rule sets in the SQL queries. Structured query language (SQL) is a programming language for storing and processing information in a relational database. A relational database stores information in tabular form, with rows and columns representing different data attributes and the various relationships between the data values. SQL statements can be used to store, update, remove, search, and retrieve information from the database. SQL can also be used to maintain and optimize database performance.

The table of FIG. 4 includes segments having segment IDs of segment0 and segment1. Each of the segments includes condition groups each having a condition group ID, and conditions having condition IDs. For an embodiment, each conditional group includes one or more conditions.

For an embodiment, each condition includes a logical filter. For example, as shown, the segment having the segment ID of segment0 includes the conditional group having the conditional group ID of group0, which include the condition having the ID condition0, which includes the logical filter of “country” EQUALS “United States”. The segment having the segment ID of segment additionally includes the conditional group having the conditional group ID of group1, which includes the condition having the ID condition1, which includes the logical filter of “state” EQUALS “Connecticut”, and the condition having the ID condition2, which includes the logical filter of “first name” NOT EQUALS “John”.

Further, for example, as shown, the segment having the segment ID of segment1 includes the conditional group having the conditional group ID of group2, which include the condition having the ID condition3, which includes the logical filter of “country” EQUALS “United States”. The segment having the segment ID of segment1 additionally includes the conditional group having the conditional group ID of group3, which includes the condition having the ID condition4, which includes the logical filter of “state” EQUALS “Connecticut”, and the condition having the ID condition5, which includes the logical filter of “state” EQUALS “Massachusetts”.

When evaluating the segment conditions for both of the segments having the segment IDS of segment0 and segment 1 of the table of FIG. 4, at the same time, on the above profile data, an unoptimized approach would involve evaluating all of the rules for each segment on every profile record. With this approach the Country EQUALS “United States” and the State EQUALS “Connecticut” logical filter would be evaluated twice for each profile (because those logical filters are used in both segments). Note how the logical filters for row numbers 2 and 4 are the same, and the logical filters for row numbers 0 and 3 are the same. The duplicate evaluation here would mean that the database would need to perform more work, which would cause the SQL query to take longer to evaluate while unnecessarily utilizing additional resources on the database. For an embodiment, in order to avoid this the way conditions are evaluated is optimized, so that each rule is only evaluated once. The result of that evaluation would then be attributed to each of the segments using that rule.

FIG. 5 shows a table created according to a mapped format allowing each condition to be evaluated once, according to an embodiment. The table of FIG. 5 includes a mapping from an original format to the mapped format. In this new representation each unique condition filter is only included once. Further, alongside the condition filter is a list of all of the references of that condition filter. The advantage of this approach is that each condition filter is only evaluated once. The results of that evaluation are attributed to every condition using that filter, thereby avoiding duplicate work which makes the system faster and more efficient.

Additional embodiments include methods, apparatuses, and systems for storing user-defined query logic in a database for filtering entity data. For an embodiment, this includes storing the transformed new user-defined segment definitions (multiple user-defined segment definitions) in the database, composing a user-defined query based on the transformed new user-defined segment definitions (multiple user-defined segment definitions) as stored in the database, and running the composed user-defined query against data tables to determine which of the entities qualify for membership in new segments based on each of the new user-defined segment definitions as determined by the logic contained in the composed user-defined query. An electronic action (such as sending an electronic message) is performed directed to sub-users identified by membership in the new segments.

Typically, segments are based on user-defined sets of rules for filtering data in a database. If the data is stored in a single analytical database, then a natural solution is to write SQL (structured query language) queries to calculate segment memberships based on this data. It is desirable to express the user-defined rule sets in the SQL queries. Structured query language (SQL) is a programming language for storing and processing information in a relational database. A relational database stores information in tabular form, with rows and columns representing different data attributes and the various relationships between the data values. SQL statements can be used to store, update, remove, search, and retrieve information from the database. SQL can also be used to maintain and optimize database performance.

One way to do this is to build the query string in code based on a list of rules of a user. However, building a syntactically correct SQL query this way is difficult and error-prone, and is also vulnerable to SQL injection attacks if the user-provided strings are not properly sanitized to remove malicious inputs. This method is also not practical if the user wants to run more than one segment simultaneously, which is required when keeping segments up to date in real time.

At least some of the described embodiments include storing a rule set (transformed new user-defined segment definitions (multiple user-defined segment definitions)) of the user in the database making the query itself generic. Therefore, any number of segments can be evaluated simultaneously in one SQL query, and the system is protected from SQL injection attacks since the query is not being pieced together from user-provided strings. That is, at least some of the described embodiments provide a technical solution to the technical problem of evaluating multiple segments simultaneously in a single query (for example, a single SQL query). Further, the operation of the computer or processor performing at least some of the described embodiments is improved by reducing the possibilities of SQL injection attacks when performing an SQL query of the database in which data being segmented is stored. SQL injection (SQLi) is a web security vulnerability that allows an attacker to interfere with the queries that an application makes to its database. This can allow an attacker to view data that they are not normally able to retrieve. This might include data that belongs to other users, or any other data that the application can access. In many cases, an attacker can modify or delete this data, causing persistent changes to the application's content or behavior.

FIG. 6 shows a system 600 for storing user-defined query logic in a database for filtering entity data, according to an embodiment. As shown, for an embodiment, the system includes a segmentation server 601 and an associated database 620. For an embodiment, the segmentation server 101 is electronically connected through a network (for example, the internet) 114 to user server 140 of a user, and to computing devices 104, 106 of sub-users 108, 112. For an embodiment, the user is a merchant, and the sub-users are customers of the merchant. For an embodiment, one or more of the entities include a profile of the sub-users (customers) of the user (merchant) 108, 112, which can be added to the database 620 through means including integrations with third-party platforms (including ecommerce providers or external customer data platforms, for example), API calls from the user's own computer systems, websites, or mobile apps, or user-initiated file uploads to the server 601. For other embodiments, one or more of the entities may include entries in a user's catalog of items for sale; user-defined custom entities such as restaurant reservations, gift cards, or event tickets; or coupon codes and associated metadata. For an embodiment, the profiles of the entities come from another platform that customers of an operator of the server integrate into their system. For example, an ecommerce provider like Shopify®, a third-party point-of-sale system in a brick-and-mortar store, or a third-party customer data platform (CDP). They can also be created by uploading files of profile data to an application or by API calls to the application (for example, from a user's own mobile application or their website).

As previously described, for an embodiment, the user of the user server 140 may initiate a segmentation process of information related to the sub-users. For example, the user may desire segmentation of email addresses of the sub-users for facilitating targeted emailing of advertising. For an embodiment, a profile (entity) of each of the sub-users is stored in the database. For an embodiment, the segmentation includes analyzing information within the profiles of the sub-users to filter the sub-users based on a user-provided criteria, which can include criteria like “profiles located in New York,” “profiles that have purchased at least 2 pairs of red pants in the last 6 months,” or “profiles whose pre-computed probability of placing an order in the next 30 days is greater than 50%” or combinations of criteria such as these.

For an embodiment, the server 601 is configured to filter entities (for an embodiment, the entities each include the previously mentioned profiles) within the database 620 based on rules of a user-defined segment definition applied to various data points associated with each entity stored in the database. For an embodiment, this includes the server 101 operating to create 611 data tables for storing user-defined segment definitions in the database, the data tables including the user-defined segment definitions and criteria, wherein the user-defined segment definitions include lists of references to the criteria, wherein the criteria include rules that are evaluated against entity data of the database to determine whether an entity should or should not qualify for a segment based on entity data associated with the entity. For an embodiment, the results of the criteria are logically aggregated using Boolean operators (AND or OR).

For an embodiment, the server 601 further operates to receive 613 new user-defined segment definitions. For an embodiment, the new user-defined segment definition is received by the server 601 from the user server 140 of the user for the purpose of generating a new segmentation process.

For an embodiment, the server 601 further operates to transform 615 the new user-defined segment definitions, wherein transforming includes representing the new user-defined segment definitions as sets of filter definition tuples, wherein the sets of filter definition tuples are based on the user-defined segment definitions and the criteria in the created data tables. For an embodiment, each of the criteria includes a definition that is a list of generic filter definition tuples. For an embodiment, the sets of filter definition tuples include conditions that must be met by a given event or trait (of the entities) for the entity (profile) to qualify for the criteria. There are a few variations in the filter tuple schema, but for an embodiment, the sets of filter definition tuples are of the form (key, operator, value) or (type, key, operator, value). An exemplary filter may include “(′some_property′, ‘eq’, 1234)” which is conceptually similar to an SQL “where” clause like “where some_property=1234”. The type field may be included to allow properties to be treated as or cast to different types at query time, which is important since an operator of the server 101 may not enforce a rigid, typed schema on customer-provided data.

For an embodiment, each filter tuple column is of an array type. When multiple filter tuples are present, they must all be satisfied together. That is, the filter tuples are combined with an AND Boolean operator.

While described as sets of filter definition tuples, at least one embodiment includes replacing the sets of filter definition tuples with a separate table with a row for each member of the set of filter definition tuples and a column for each field in each the set of filter definition tuples, which can be joined to the remaining parts of the user-defined segment definition.

For an embodiment, the server 601 further operates to store 617 the transformed new user-defined segment definitions (multiple user-defined segment definitions) in the database. It is to be understood that for an embodiment the transformed new user-defined segment definitions (multiple user-defined segment definitions) are the multiple user-defined segment definitions of the user-defined query of 111, 113, and 210. As previously described, at least some of the described embodiments include storing a rule set of the user (that is, the transformed new user-defined segment definitions (multiple user-defined segment definitions)) in the database making the query itself generic. That way, any number of segments can be evaluated simultaneously in one SQL query, and the system is protected from SQL injection attacks since the query is not being pieced together from user-provided strings. That is, at least some of the described embodiments provide a technical solution to the technical problem of evaluating multiple segments simultaneously in a single query (for example, a single SQL query). Further, the operation of the computer or processor performing at least some of the described embodiments is improved by reducing the possibilities of SQL injection attacks when performing an SQL query of the database in which data being segmented is stored.

For an embodiment, the server 101 further operates to compose 118 a user-defined query based on the transformed new user-defined segment definitions (multiple user-defined segment definitions) as stored in the database, wherein the user-defined query contains logic that interprets the sets of filter definition tuples and performs the SQL operation or function call that is represented by each filter tuple of the sets of filter definition tuples. For example, a filter tuple “(‘price’, ‘gt’, ‘50’)” may be interpreted as a SQL condition “WHERE price>50”, or a filter tuple “(′email′, ‘ends—with’, ‘example.com’)” may be interpreted as a SQL condition “WHERE endsWith (email, ‘example.com’)” (assuming the database provides a built-in function “endsWith” for this purpose). This enables calls to functions to be built into the SQL implementation provided by the database. Another way of saying this is that this is where the filter tuples become standard SQL, but in a way that is not prone to SQL injection attacks.

For an embodiment, the server 101 further operates to run 119 the composed user-defined query against the data tables to determine which of the entities qualify for membership in new segments based on each of the new user-defined segment definitions as determined by the logic contained in the composed user-defined query. For an embodiment, the operation of running the composed user-defined query consists of running a predefined SQL query that combines the criteria to evaluate from the criterion tables with the data from the entity data tables to determine which entities qualify for membership in the segment. As previously described, the sets of filter definition tuples are based on the user-defined segment definitions and the criteria in the created data tables.

For an embodiment, the segmentation process includes implementing filters using user-defined SQL functions in an analytical database. These are essentially large if/else trees with a case for each operator, where the operators include simple things like “eq” (equals), “gt” (greater than), or “contains”, but also more complex things like conditions on time relative to now (“in-the-last”, “anniversary-in-the-next”).

For an embodiment, at query time (running the composed user-defined query), segment definitions are used to filter entity (profile) data and event histories to decide if profiles belong in the segments. In general, many segments are evaluated simultaneously. For an embodiment, desired definitions from the tables described are selected, and these definitions are joined to pre-filtered subsets of the event and trait data tables in the analytical database. An embodiment includes pre-filtering to select only the subset of data that is relevant for the set of segments being evaluated.

For an embodiment, for event data, each event is filtered first on its properties by iterating over each property filter tuple, evaluating it using the filtering functions, and combining the results with an AND. Events that don't satisfy the filter are removed from consideration. The remaining events are then grouped by the entity they are related to, and the event count and total event value are aggregated, where the event value corresponds to things like the price of purchased items. Filters on the event count or total event value are then applied to these aggregates, and this determines whether or not an entity (profile) qualifies for this event criterion. As previously described, the profile may be of one of the sub-users of the user.

For an embodiment, a similar procedure is followed as trait criteria as the property criterion. The trait data is loaded, and the properties associated with that trait are filtered like the event properties were filtered above. For an embodiment, the difference is that there is only one trait row for each profile and trait type, so there's no aggregation involved. If the trait row passes the combined property filters, then the profile qualifies for this criterion. Finally, criterion results are combined to give the overall segment results.

For an embodiment, the entity or entities include something that the data in the data tables is associated with, and which can qualify for membership in a segment based on the user-defined segment definition. As described, for an embodiment, each entity is a profile. However, for at least some other embodiment, an entity may include catalog items sold by an ecommerce store, or user-defined objects representing things like concert tickets, coupons, or appointment bookings.

For at least some embodiments, segments or a segment include a list of entities whose membership is determined by evaluating the composed user-defined query based on the user-defined segment definition.

For at least some embodiments, the user-defined segment definitions include a collection of rules determining the membership of a segment, where the rules can be transformed into sets of filter definition tuples.

For an embodiment, the data points associated with each profile/entity include profile activity history (recorded events for things like receiving an email, placing an order, viewing a product on the customer's website, etc., including user-defined custom event types). For an embodiment, the data points associated with each profile/entity include attributes specific to the profile (called profile “traits”), including, for example, the profile's contact information (email, phone number, push notification tokens, etc.), location data (mailing addresses, IP addresses, locations derived from IP addresses, time zone, etc.), consent to receive marketing communications, memberships in certain mailing lists, other values derived from machine learning algorithms, etc.

For an embodiment, data points for other types of entity are different, but have a similar structure. For example, entities representing catalog items might have traits for the inventory of that item in stock and attributes about the item like its size or color, and the events for these catalog item entities might include changes in inventory level.

For an embodiment, the data tables are tables in a database that contain the event and trait data associated with each entity, or the user-defined segment definitions (after the transformation), or the criteria that make up the definition. For an embodiment, this includes, for example, a criterion based on the entity's event history and a criterion based on properties about the entity.

For an embodiment, the criteria include rules that are evaluated as part of a user-defined segment definition. For at least some embodiments, the rules include one or more of a profile's email address ends with “example.com”, a profile's phone number is not blank, a profile has given consent to receive SMS marketing messages, a profile has placed orders in the last 6 months whose total revenue is greater than $1000, a profile has ordered a product with the category “Pants” at least 4 times between Mar. 1, 2023, and Aug. 6, 2023, a profile's location is within 10 miles of the postal code 12345 in the United States.

A previously described, for an embodiment, each entity includes a profile. For an embodiment, a profile represents a person (sub-user) who the user can communicate with or collect information about. For example, if the user runs an ecommerce store, the profile represents a single customer (sub-user) of that store.

For an embodiment, lists of references to the criteria include lists of the IDs of criteria, where each ID is an arbitrary and unique value that can be used to unambiguously refer to a single criterion.

For an embodiment, a set of filter definition tuples include a set of transformed representations of the criteria. These map directly to operations that the database knows how to perform. For example:
Criterion: Profile's email address ends with “example.com”
   Tuple: (“email”, “ends—with”, “example.com”).
      DB operation (psuedocode): WHERE endsWith (email, “example.com”)
Criterion: Profile has ordered a product with the category “Pants” at least 4 times between Mar. 1, 2023, and Aug. 6, 2023.
   Tuple: (“Category”, “eq”, “Pants”)
      DB operation: WHERE Category= “Pants”
   Other tuple (very roughly): (“count”, “gte”, 4)
      DB operation: HAVING count ( )>=4

For an embodiment, logic that implements the sets of filter definition tuples as calls to functions implemented by the database.

For at least some embodiments, the user-defined segment definitions include the criteria and rules for combining the results of these criteria with Boolean operations AND and OR. For an embodiment, the composed user-defined query aggregates the results by entity and user-defined segment to find all entities that qualify for the user-defined segment based on the rules from the segment definition for combining the results of the criteria. For example, this may include grouping together some criteria with a Boolean OR operation, and then combine the result of this with other criteria using a Boolean AND operation.

FIG. 7 is a flow chart that includes steps of a method for storing user-defined query logic in a database for filtering entity data, according to an embodiment. A first step 710 includes creating data tables for storing user-defined segment definitions in the database, the data tables including the user-defined segment definitions and criteria, wherein the criteria include rules that are evaluated against entity data of the database to determine whether an entity should or should not qualify for a segment based on entity data associated with the entity. For an embodiment, the user-defined segment definitions include lists of references to the criteria and operators. For an embodiment, the operators include, for example, “equals”, “greater than”, or “less than.” For an embodiment, the criteria include sets of (attribute name, operator, value), such as, (email, equals, “something@something.com”). A second step 720 includes receiving, by a segmentation system, new user-defined segment definitions. A third step 730 includes transforming, by the segmentation system, the new user-defined segment definitions, wherein transforming includes representing the new user-defined segment definitions as sets of filter definition tuples, wherein the sets of filter definition tuples are based on the user-defined segment definitions and the criteria in the created data tables. A fourth step 740 includes storing, by the segmentation system, the transformed new user-defined segment definitions (multiple user-defined segment definitions) in the database. A fifth step 750 includes composing a user-defined query based on the transformed new user-defined segment definitions (multiple user-defined segment definitions) as stored in the database, wherein the user-defined query contains logic that interprets the sets of filter definition tuples as native operations provided by the database. For an embodiment, native operations include operations built into the database as opposed to being separately defined. A sixth step 760 includes running the composed user-defined query against the data tables to determine which of the entities qualify for membership in new segments based on each of the new user-defined segment definitions as determined by the logic contained in the composed user-defined query. For an embodiment, the segmentation of the entities provides a filtered set of entities per the new user-defined segment definitions.

As previously described, while described as sets of filter definition tuples, at least one embodiment includes replacing the sets of filter definition tuples with a separate table with a row for each member of the set of filter definition tuples and a column for each field in each the set of filter definition tuples, which can be joined to the remaining parts of the user-defined segment definition.

### Transforming New User-Defined Segment Definitions

As previously stated, an embodiment includes transforming, by the segmentation system, the new user-defined segment definitions, wherein transforming includes representing the new user-defined segment definitions as sets of filter definition tuples, wherein the sets of filter definition tuples are based on the user-defined segment definitions and the criteria in the created data tables. As previously described, for an embodiment, each of the criteria includes a definition that is a list of generic filter definition tuples. For an embodiment, the sets of filter definition tuples include conditions that must be met by a given event or trait (of the entities) for the entity (profile) to qualify for the criteria. There are a few variations in the filter tuple schema, but for an embodiment, the sets of filter definition tuples are of the form (key, operator, value) or (type, key, operator, value). An exemplary filter may include “(′some_property′, ‘eq’, 1234)” which is conceptually similar to an SQL “where” clause like “where some_property=1234”. The type field may be included to allow properties to be treated as or cast to different types at query time, which is important since an operator of the server 101 may not enforce a rigid, typed schema on customer-provided data. For an embodiment, events are actions that a profile has taken, like placing an order, receiving an email, and/or opening an SMS message.

### Composing the User-Defined Query

As previously stated, an embodiment includes composing a user-defined query based on the transformed new user-defined segment definitions (multiple user-defined segment definitions) as stored in the database, wherein the user-defined query contains logic that interprets the sets of filter definition tuples as native operations provided by the database. For an embodiment, native operations include operations built into the database as opposed to being separately defined. Further, as previously described, for an embodiment, the user-defined query contains logic that interprets the sets of filter definition tuples and performs the SQL operation or function call that is represented by each filter tuple of the sets of filter definition tuples. For example, a filter tuple “(‘price’, ‘gt’, ‘50’)” may be interpreted as a SQL condition “WHERE price>50”, or a filter tuple “(′email′, ‘ends—with’, ‘example.com’)” may be interpreted as a SQL condition “WHERE endsWith (email, ‘example.com’)” (assuming the database provides a built-in function “endsWith” for this purpose). This enables calls to functions to be built into the SQL implementation provided by the database. Another way of saying this is that this is where the filter tuples become standard SQL, but in a way that is not prone to SQL injection attacks.

### Running the Composed User-Defined Query

As previously stated, an embodiment includes running the composed user-defined query against the data tables to determine which of the entities qualify for membership in new segments based on each of the new user-defined segment definitions as determined by the logic contained in the composed user-defined query. As previously described, for an embodiment, the operation of running the composed user-defined query consists of running a predefined SQL query that combines the criteria to evaluate from the criterion tables with the data from the entity data tables to determine which entities qualify for membership in the segment. As previously described, the sets of filter definition tuples are based on the user-defined segment definitions and the criteria in the created data tables. Structured query language (SQL) is a programming language for storing and processing information in a relational database. A relational database stores information in tabular form, with rows and columns representing different data attributes and the various relationships between the data values. SQL statements can be used to store, update, remove, search, and retrieve information from the database. SQL can also be used to maintain and optimize database performance. For an embodiment, the database query (such as the composed user-defined query) is a request for data from the database. The request comes in a database table or a combination of tables using a code known as the query language. This way, the database can understand and process the query accordingly.

At least some embodiments further include electronically performing an action directed to sub-users identified by membership in the new segments. For an embodiment, the action includes electronically messaging sub-users that were filtered by the composed user-defined query. For at least some embodiments, the segments are created to target marketing email and/or SMS messages to a group of people based on the conditions in the segment definition.

For an embodiment, each of the entities comprises a profile, wherein each profile represents a person (sub-user) that the user can communicate with or collect information about. For example, if the user runs an ecommerce store, the profile represents a single customer (sub-user) of that store.

For an embodiment, each segment includes a list of entities, wherein membership of each of the entities is determined by the composed user-defined query based on the new user-defined segment definitions. For an embodiment, one or more of the entities include a profile of the sub-users (customers) of the user (merchant), which can be added to the database through means including integrations with third-party platforms (including ecommerce providers or external customer data platforms, for example), API calls from the user's own computer systems, websites, or mobile apps, or user-initiated file uploads to the server. For other embodiments, one or more of the entities may include entries in a user's catalog of items for sale; user-defined custom entities such as restaurant reservations, gift cards, or event tickets; or coupon codes and associated metadata. For an embodiment, the profiles of the entities come from another platform that customers of an operator of the server integrate into their system. For example, an ecommerce provider like Shopify®, a third-party point-of-sale system in a brick-and-mortar store, or a third-party customer data platform (CDP). They can also be created by uploading files of profile data to an application or by API calls to the application (for example, from a user's own mobile application or their website).

For at least some embodiments, running the composed user-defined query provides for filtering for multiple segments simultaneously. This is possible because the transformed new user-defined segment definitions (multiple user-defined segment definitions) are stored in the database and read at query time. For an embodiment, the query is written to interpret these filter definition tuples (rules) stored in the database and execute them as standard SQL/Database functions. For an embodiment, the query knows how to interpret the text (tuples) stored in the database and execute them as query logic.

At least some embodiments further include creating and storing a trait and event table in the database as a part of the entity data of the data tables. For an embodiment, the entity data includes an email address of a sub-user. For an embodiment, traits are properties of a profile. This is generally things that profiles have only a few of, and things that are not filtered based on the number of. Traits may include email, phone number, properties, and/or a subscription status.

For an embodiment, the entity data includes time-series data. For an embodiment, the time-series data includes at least one of a purchase history or an email history of a sub-user. For an embodiment, a profile (entity) may have data points that are associated 1:1 with the profile, like an email address or a postal address. However, for an embodiment, the profile may also have time-series data associated with it, including event timelines like purchase history or a history of emails received.

At least some embodiments further include updating the overall segments as entity data changes. For an embodiment, updating the overall segments as entity data changes includes sensing changes in the entity data, and automatically re-running the composed user-defined query against the data tables to determine which of the entities qualify for membership in new segments based on each of the new user-defined segment definitions as determined by the logic contained in the composed user-defined query. For an embodiment, sensing greater than a change threshold of changes to the entity data triggers the updating of the overall segments.

At least some embodiments further include electronically sending messages to sub-users identified by membership in new segments. This may include sending emails, SMS messages, push notifications, or other communications to targeted audiences of people (sub-users).

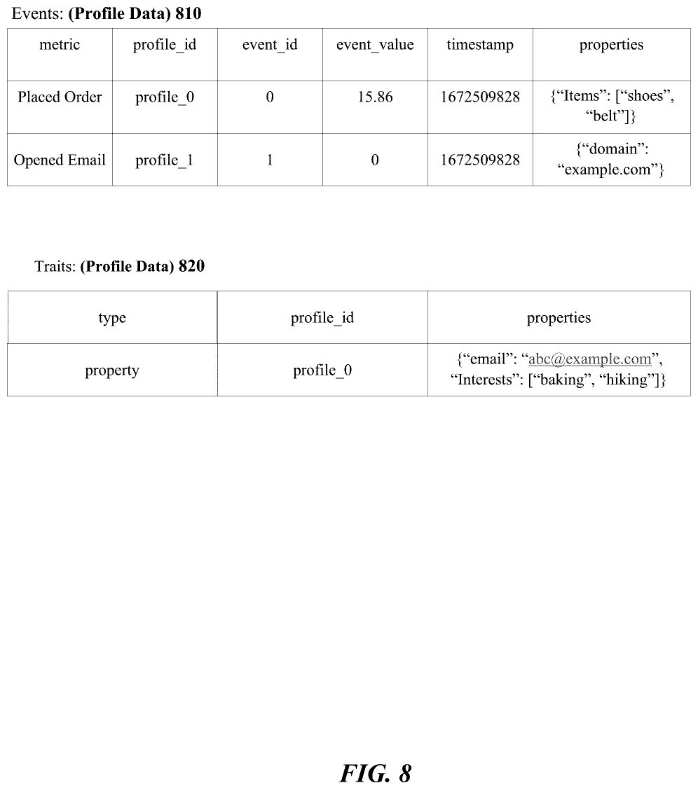

FIG. 8 shows tables of profile data, according to an embodiment. As previously described, for an embodiment, each entity includes profile data. As shown, for an embodiment, the profile data includes events data 810 which can include a metric, an event_id, an event_value, a timestamp, and properties.

Further, as shown, for an embodiment, the profile data includes traits data 820 which include, for example, a type, a profile_id, and properties.

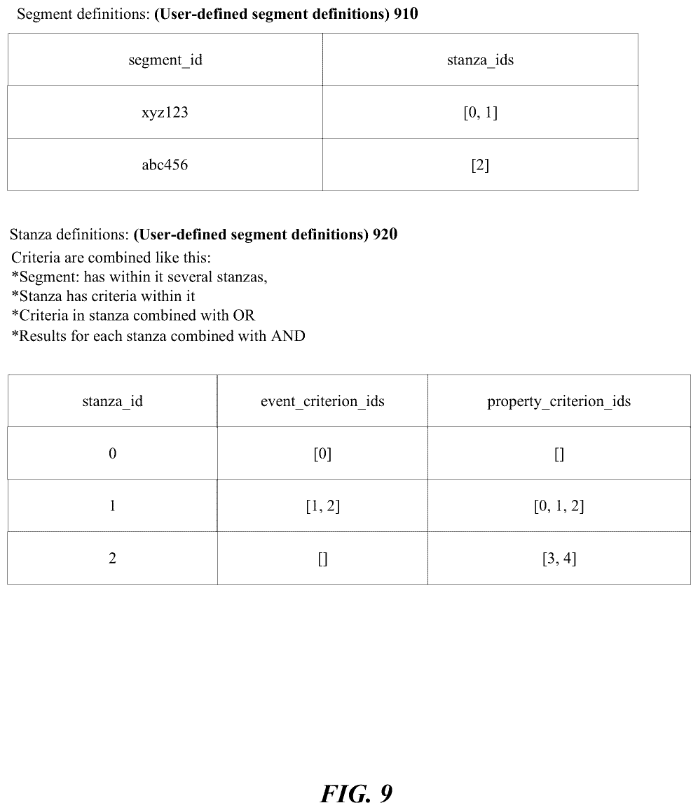

FIG. 9 shows tables of user-defined segment definitions 910, 920, according to an embodiment. The user-defined segment definitions 910 includes a segment_id and a stanza_id. For an embodiment, the user-defined segment definitions 920 includes a stanza_id, event_criterion_ids, and property_criterion_ids. For an embodiment, these IDs are all randomly chosen values that allow for cross-referencing the stanzas, criteria, and segments and linking them together.

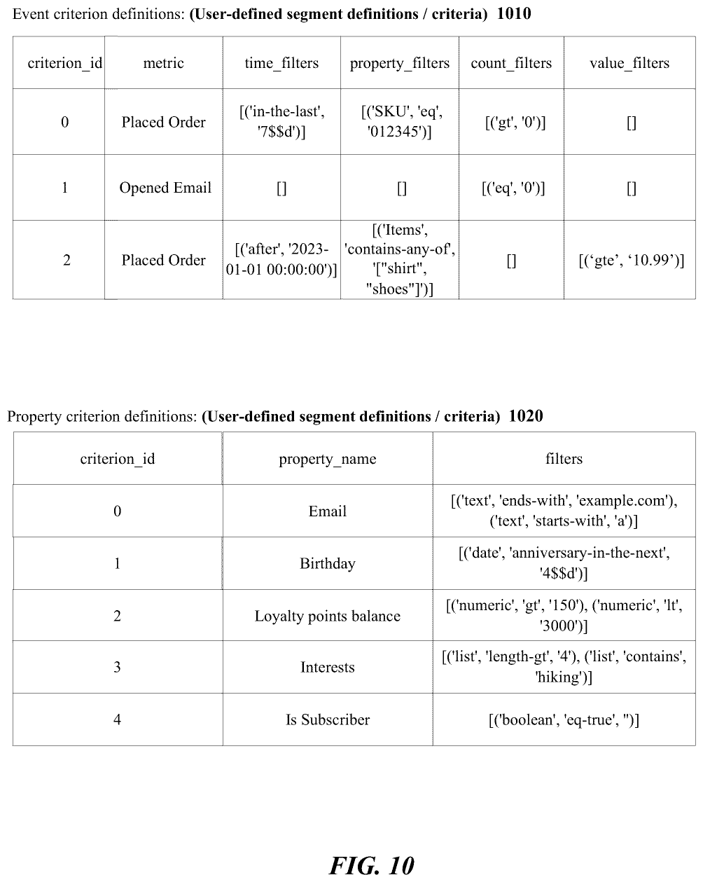

FIG. 10 shows additional tables of user-defined segment definitions, according to an embodiment. Examples of filter tuples are shown between square brackets in the right-most columns of each table. Each filter tuple is enclosed in parentheses.

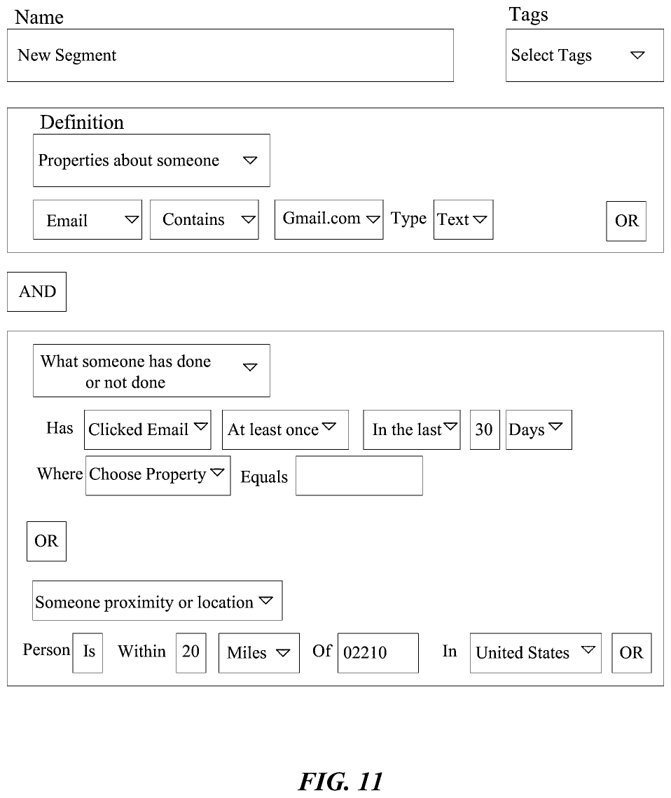

FIG. 11 shows a user interface of a system for storing user-defined query logic in a database for filtering entity data, according to an embodiment.

Although specific embodiments have been described and illustrated, the embodiments are not to be limited to the specific forms or arrangements of parts so described and illustrated. The described embodiments are to only be limited by the claims.

What is claimed:

1. A method of filtering entities within a database based on rules of a user-defined segment definition, comprising:
identifying, by a server, a user-defined query, wherein the user-defined query comprises multiple user-defined segment definitions, wherein an original format of each of the user-defined segment definitions include one or more condition groups, wherein each conditional group includes one or more conditions, wherein each condition includes a logical filter, a field indicating which condition group includes the condition, and fields denoting which user-defined segment definitions include the logical filter;
mapping, by the server, each logical filter to one or more of the user-defined segment definitions based on the fields of each condition, and parsing a sub-component of a logical date-filter a single time and storing the sub-component of the logical date-filter in the database when at least one of the logical filters is the logical date-based filter;
executing, by the server, each of the logical filters on a plurality of entities of the database, wherein each of the logical filters is executed a single time;
storing, by the server, filtered results in a mapped format based on the executing of the logical filters according to the mapping in the database;
converting, by the server, from the mapped format into the original format of the user-defined segment definitions that represents the set of entities that qualify for user-defined segments;
identifying, by the server, which entities qualify to be included within the user-defined segment definitions comprising logically combining the conditions and the condition groups; and
electronically performing, by the server, an action directed to users of the entities qualified to be within the user-defined segment definitions.

2. The method of claim 1, wherein logically combining the conditions and the condition groups comprises combining the results by “OR”ing each condition and “AND”ing each condition group.

3. The method of claim 1, wherein executing each of the logical filters on the plurality of entities of the database comprises:
reading entities from the database;
SQL joining the entities to the mapped logical filters; and
evaluating each of the logical filters on each of the entities.

4. The method of claim 1, wherein the sub-component of each logical date-filter includes a date string, wherein the date string includes a start date, an end date, and a unit.

5. The method of claim 1, wherein parsing a date string of the logical date-filter a single time and storing the parsed date string of the logical date-filter in the database further comprises:
storing a field of each logical date-filter in a dedicated column.

6. The method of claim 1, wherein identifying the user-defined query comprises:
creating data tables for storing user-defined segment definitions in the database, the data tables including the user-defined segment definitions and criteria, wherein the criteria include rules (logical filters) that are evaluated against entity data of the database to determine whether an entity should or should not qualify for a segment based on entity data associated with the entity;
receiving, by a segmentation system, new user-defined segment definitions;
identifying the multiple user-defined segment definitions comprising transforming, by the segmentation system, the new user-defined segment definitions, wherein transforming includes representing the new user-defined segment definitions as sets of filter definition tuples, wherein the sets of filter definition tuples are based on the user-defined segment definitions and the criteria in the created data tables; and
storing, by the segmentation system, the multiple user-defined segment definitions in the database, wherein each of the multiple user-defined segment definitions include one or more condition groups, each of which includes one or more conditions, wherein each condition includes a logical filter, a field indicating which condition group includes the condition, and fields denoting which user-defined segment definitions include the logical filter;
wherein the user-defined query comprises the multiple user-defined segment definitions.

7. The method of claim 6, further comprising:
composing a user-defined query based on the multiple user-defined segment definitions as stored in the database, wherein the user-defined query contains logic that interprets the sets of filter definition tuples as native operations wherein identifying which entities qualify to be included within the user-defined segment definitions comprises running the composed user-defined query against the data tables to determine which of the entities qualify for membership in new segments based on each of the new user-defined segment definitions as determined by the logic contained in the composed user-defined query.

8. The method of claim 7, wherein running the composed user-defined query against the data tables provides a filtered set of entities per the new user-defined segment definitions.

9. The method of claim 7, further comprising electronically performing an action directed to users identified by membership in the new segments.

10. The method of claim 1, wherein each of the entities comprises a profile, wherein each profile comprises information of sub-users, wherein the sub-users are customers of the user.

11. The method of claim 6, wherein each segment includes a list of entities, wherein membership of each of the entities is determined by the composed user-defined query based on the new user-defined segment definitions.

12. The method of claim 1, wherein identifying which entities qualify to be included within the user-defined segment definitions includes filtering for multiple segments simultaneously.

13. The method of claim 1, further comprising creating and storing a trait and event table in the database as a part of the entity data of the data tables.

14. The method of claim 13, wherein the entity data includes an email address of a sub-user.

15. The method of claim 1, wherein the entity data includes time-series data.

16. The method of claim 14, wherein the time-series data includes an electronic history.

17. The method of claim 6, further comprising updating the multiple user-defined segment definitions as entity data changes, comprising:
sensing changes in the entity data; and
automatically re-running the composed user-defined query against the data tables to determine which of the entities qualify for membership in new segments based on each of the new user-defined segment definitions as determined by the logic contained in the composed user-defined query.

18. The method of claim 6, further comprising:
electronically sending messages to sub-users identified by membership in the new segments.

19. A system for filtering entities based on rules of a user-defined segment definition, comprising:
a server;
a database, wherein entities are stored in the database;
a user server electronically connected to the server;
sub-user computing devices electronically connected to the server and the user server, wherein the entity data includes data of sub-users of the sub-user computing devices;
the server configured to:
identifying a user-defined query, wherein the user-defined query comprises multiple user-defined segment definitions, wherein an original format of each of the user-defined segment definitions include one or more condition groups, wherein each conditional group includes one or more conditions, wherein each condition includes a logical filter, a field indicating which condition group includes the condition, and fields denoting which user-defined segment definitions include the logical filter;
map each logical filter to one or more of the user-defined segment definitions based on the fields of each condition, and parsing a sub-component of a logical date-filter a single time and storing the sub-component of the logical date-filter in the database when at least one of the logical filters is the logical date-based filter;
execute each of the logical filters on a plurality of entities of the database, wherein each of the logical filters is executed a single time;
store filtered results in a mapped format based on the executing of the logical filters according to the mapping in the database;
convert from the mapped format into the original format of the user-defined segment definitions that represents the set of entities that qualify for user-defined segments;
identifying which entities qualify to be included within the user-defined segment definitions comprising logically combining the conditions and the condition groups; and
electronically performing an action directed to sub-users of the entities qualified to be within the user-defined segment definitions.

20. The method of claim 1, wherein identifying the user-defined query comprises the server operating to:
create data tables for storing user-defined segment definitions in the database, the data tables including the user-defined segment definitions and criteria, wherein the criteria include rules (logical filters) that are evaluated against entity data of the database to determine whether an entity should or should not qualify for a segment based on entity data associated with the entity;
receive new user-defined segment definitions;
identify the multiple user-defined segment definitions comprising transforming, by the segmentation system, the new user-defined segment definitions, wherein transforming includes representing the new user-defined segment definitions as sets of filter definition tuples, wherein the sets of filter definition tuples are based on the user-defined segment definitions and the criteria in the created data tables; and
store the multiple user-defined segment definitions in the database, wherein each of the multiple user-defined segment definitions include one or more condition groups, each of which includes one or more conditions, wherein each condition includes a logical filter, a field indicating which condition group includes the condition, and fields denoting which user-defined segment definitions include the logical filter;
wherein the user-defined query comprises the multiple user-defined segment definitions.
